(19) United States
(12) Patent Application Publication
(10) Pub. No.: US 2018/0121933 A1
(43) Pub. Date: May 3, 2018

(54) INSPECTION SYSTEM AND INSPECTION METHOD FOR COMMODITY UNIQUENESS CONFIRMATION

(71) Applicant: Dande Image Master Co., Ltd., Zhuhai, Zhuhai (CN)

(72) Inventors: Jinan Chen, Zhuhai (CN); Xiangrui Qin, Zhuhai (CN)

(21) Appl. No.: 15/723,210

(22) Filed: Oct. 3, 2017

(30) Foreign Application Priority Data
Oct. 28, 2016 (CN) 201610971442.X

(51) Int. Cl. G06Q 30/00; G06K 19/06; H04L 9/08; H04L 9/06; H04L 9/30

(52) U.S. Cl. CPC G06Q 30/0185; G06K 19/06037; H04L 9/302; H04L 9/0825; H04L 9/0643; G06K 19/06018

(57) ABSTRACT

Related are an inspection method and an inspection method for commodity uniqueness confirmation. The inspection system includes an outer code label, an inner code label, a mobile terminal and a remote server. An image of the outer code label printed on the surface of the commodity packaging box and overlaid with the anti-counterfeiting information A is shot by the mobile terminal; after the commodity packaging box is unwrapped, the inner code information B on the inner code label is input and is uploaded to the remote server together with the image; and the remote server performs analysis and comparison on the image of the outer code label, feeds commodity information back to the mobile terminal, and simultaneously after inspecting and determining a commodity uniqueness, feeds the commodity uniqueness to the mobile terminal.

### CROSS-REFERENCE TO PRIOR APPLICATION

The present application claims the benefit of Chinese Patent Application No. 201610971442.X filed on Oct. 28, 2016, the contents of which are incorporated herein by reference.

### TECHNICAL FIELD

The disclosure belongs to the technical field of commodity anti-counterfeiting, and more particularly, relates to an inspection system and an inspection method for commodity uniqueness confirmation.

### BACKGROUND

At present, for authenticity of a commodity on a market, except for the identification of a merchant on the commodity in itself on a professional level, main methods that a general user may participate in the identification includes: printing various anti-counterfeiting marks or labels on a commodity packaging design, such as a tiny text, a special ink, a watermark and a laser anti-counterfeiting.

Along with the development of a Computer and Information Technology (ICT), an electronic label represented by Radio Frequency Identification Devices (RFID), a password way represented by a pseudo-random number, and the like all are applied to authenticity identification. The number may be directly printed on the label, and also may be presented to a user using an encoding way such as a barcode and a two-dimensional code.

### SUMMARY

However, for the existing anti-counterfeiting labels commonly seen on the market such as the tiny text, the special ink, the watermark and the laser anti-counterfeiting label, the counterfeiting is relatively easy as long as there are corresponding printing machine.

If an electronic label is used, the cost will be greatly improved and there will be a need for a corresponding reading device. In this sense, it is not an identifying method that the general user may participate.

For the password way using the unique pseudo-random number, the cost is low, the user notifies the merchant of the number printed on the purchased commodity by means of a telephone/a webpage/a short message and the like, and the merchant compares it with the number in a database to conclude whether there exists the number in the database. If there does not exist the number, it is concluded that the number is counterfeited or is input mistakenly and the user is notified that the number does not exist; and if there exists the number, the user is registered and notified of how many times he/she queries. In case one number is counterfeited on a massive scale, there will be a plurality of users to query this number; and meanwhile, the merchant may take an action and thus the users also can know that the purchased commodity may be not a quality product. Its defects lie in: whatever communication methods are adopted by the user, the identification is achieved by means of that the user directly notifies the printed number to the merchant. The merchant cannot determine whether the user is input mistakenly or the number is counterfeited even through knowing that the random number notified by the user does not exist. With regard to a method for improving a misinput, the number is printed into the barcode or the two-dimensional code and the like, such that the user reads the number using scanning software and duplicates the number to upload. And meanwhile, a plain code is directly notified to the merchant. Even if the misinput is improved, it is still difficult to prevent the malicious query and therefore the normal statistics and tracking of the merchant are disturbed.

To solve the above problems existed in the related art, the disclosure provides an inspection system and an inspection method, which are simple and convenient in operation and through which the commodity uniqueness can be confirmed, and while the misinput is prevented, the malicious query, the disturbance to correct statistics and tracking of the merchant, and the failure to feed back the correct commodity information and the uniqueness confirmation are prevented, thereby achieving the anti-counterfeiting purpose.

To solve the above technical problems, the technical scheme adopted by the disclosure is as follows:

An inspection system for commodity uniqueness confirmation includes an outer code label, an inner code label, a mobile terminal and a remote server.

The outer code label is a pattern printed on a surface of a commodity packaging box and overlaid with anti-counterfeiting information A. The inner code label is arranged inside the commodity packaging box, on which inner code information B covered by a coating can be scraped.

The mobile terminal is a terminal device having image collection and mobile communication functions, and is mainly configured to collect a pattern overlaid with the anti-counterfeiting information A, and the inner code information B, and upload the pattern overlaid with the anti-counterfeiting information A, and the inner code information B together to the remote server via a wireless communication network.

The remote server is mainly configured to perform analysis on the uploaded pattern overlaid with the anti-counterfeiting information A, compare the pattern and the inner code information B together with information in a commodity information database, determine a uniqueness of a purchased commodity and feed back to the mobile terminal.

The mobile terminal is connected with the remote server via the mobile communication network.

Further, the anti-counterfeiting information A is overlaid and printed on the surface of the commodity packaging box with the following method: first of all, image information and the anti-counterfeiting information A are obtained, and the anti-counterfeiting information A is encoded and is added to concentration information I of the image information; and then, the concentration information I added with the anti-counterfeiting information A is restored into a color image and the color image is directly printed on the surface of the commodity packaging box via a printer.

Further, the anti-counterfeiting information A is to perform encryption and fragmentation on the commodity information to form one of two half codes that are uniquely corresponding; and the other half code is stored to a commodity information database of the remote server.

Further, “to perform the encryption and the fragmentation on the commodity information to form the two half codes that are uniquely corresponding” is specifically as follows: the commodity information is encrypted first using a data transformation algorithm, and then the encrypted commodity information is extracted according to a special rule and format and is fragmented into the two half codes; or the commodity information is extracted according to the special rule or format and is fragmented into the two half codes, and then, the two half codes are encrypted using the data transformation algorithm.

Further, the data transformation algorithm refers to a symmetric or asymmetric key algorithm, or a Triple Data Encryption Algorithm (3DES), Rivest-Shamir-Adleman (RSA), HASH or Message-Digest Algorithm 5 (MD5) encryption algorithm. The special rule and format refer to a front-to-rear split-half method or a fixed format.

Further, the pattern overlaid with the anti-counterfeiting information A is a two-dimensional code, a barcode or a graph.

An inspection method for commodity uniqueness confirmation includes the following steps.

First of all, an image of an outer code label printed on a surface of a commodity packaging box and overlaid with anti-counterfeiting information A is shot by a mobile terminal.

Then, the image of the outer code label is uploaded to a remote server after being corrected by the mobile terminal; and thereafter, after the commodity packaging box is unwrapped, inner code information B on an inner code label is input and is uploaded to the remote server.

At last, the remote server performs analysis on the uploaded image of the outer code label to obtain overlaid anti-counterfeiting information A, pairs with information in a commodity information database via the anti-counterfeiting information A and the inner code information B, inspects, and feeds corresponding information of a purchased commodity back to the mobile terminal; and meanwhile, the remote server updates a statistical record of a sold database, determines a uniqueness of the purchased commodity and feeds an inspected unique structure back to the mobile terminal.

Further, the mobile terminal further identifies a correspondence address of a remote server of a merchant corresponding to the image of the outer code label while correcting the image of the outer code label, and uploads the corrected image of the outer code label and the inner code information B to the remote server at the correspondence address.

The disclosure has the following beneficial effects.

Through the above technical scheme, the commodity uniqueness can be confirmed, the operation is simple and convenient, and while the misinput is prevented, the malicious query as well as the disturbance to correct statistics and tracking of the merchant is avoided; moreover, the inner code information B of the inner code label is not known before the commodity is purchased, so after the commodity is purchased, it is difficult to reversely deduce out the anti-counterfeiting information A by referring to outer image information; the uploaded image of the counterfeited outer code label cannot be analyzed by the remote server of the merchant, such that the correct commodity information and the uniqueness confirmation cannot be fed back; and thus, the large-scale counterfeiting cannot be implemented, and the anti-counterfeiting purpose is achieved.

### BRIEF DESCRIPTION OF THE DRAWINGS

FIG. 1 is a structure diagram of an embodiment of an inspection system for commodity uniqueness confirmation of the disclosure.

FIG. 2 is a flowchart of an inspection method of an inspection system for commodity uniqueness confirmation of the disclosure.

### DETAILED DESCRIPTION

In order to make the purpose, technical scheme and advantages of the disclosure more clear, the disclosure will be further described below in detail with reference to accompanying drawings and embodiments. It should be understood that the specific embodiments described here are merely to explain the disclosure and are not intended to limit the disclosure.

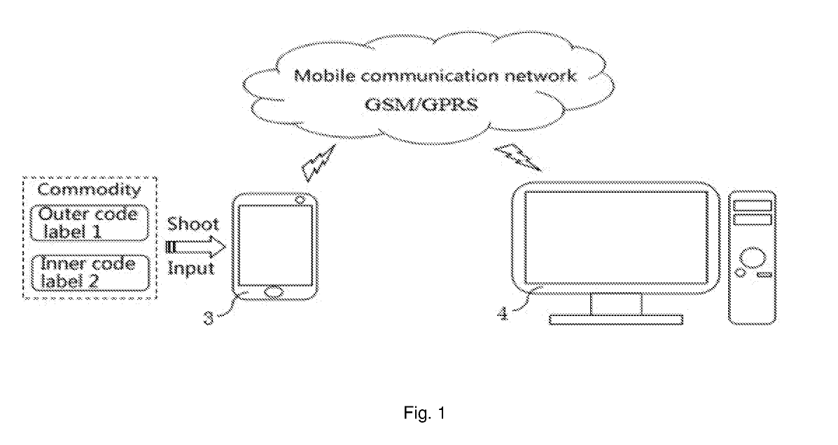

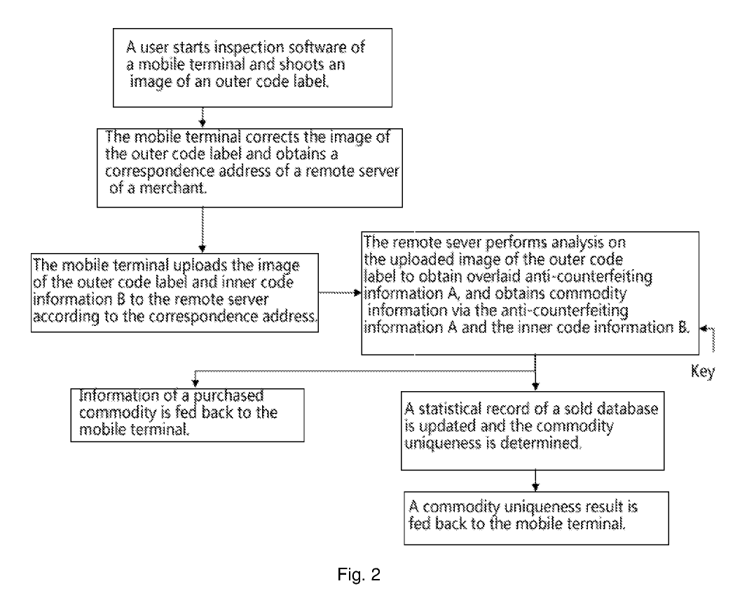

As shown in FIG. 1 and FIG. 2:

An inspection system for commodity uniqueness confirmation in the embodiments of the disclosure includes an outer code label 1, an inner code label 2, a mobile terminal 3 and a remote server 4. The mobile terminal 3 is connected with the remote server 4 via a mobile communication network 5. The outer code label 1 is a pattern printed on a surface of a commodity packaging box and overlaid with anti-counterfeiting information A. The pattern overlaid with the anti-counterfeiting information A. is a two-dimensional code, a barcode or a graph. The inner code label 2 is arranged inside the commodity packaging box, on which inner code information B covered by a coating can be scraped. The mobile terminal 3 may be a terminal device having image collection and mobile communication functions such as an intelligent mobile phone or a tablet computer, and is mainly configured to collect a pattern overlaid with the anti-counterfeiting information A, and the inner code information B, and upload the pattern overlaid with the anti-counterfeiting information A, and the inner code information B to the remote server 4 via the wireless communication network 5. The remote server 4 is mainly configured to perform analysis on the uploaded pattern overlaid with the anti-counterfeiting information A, compare the pattern and the inner code information B together with information in a commodity information database, determine a uniqueness of a purchased commodity and feed back to the mobile terminal 3.

Wherein, the anti-counterfeiting information A is overlaid and printed on the surface of the commodity packaging box with the following method, and here, the anti-counterfeiting information A cannot be perceived and identified by human eyes after being overlaid to the pattern and may effectively prevent the large-scale duplication. The overlaying and printing method is as follows: first of all, image information and the anti-counterfeiting information A are obtained, and the anti-counterfeiting information A is encoded and is added to concentration information I of the image information; and then, the concentration information I added with the anti-counterfeiting information A is restored into a color image and the color image is directly printed on the surface of the commodity packaging box via a printer. The anti-counterfeiting information A may be to perform encryption and fragmentation on the commodity information to form two half codes that are uniquely corresponding (that is, the commodity information is encrypted first using a data transformation algorithm such as a symmetric or asymmetric key algorithm, a 3DES encryption algorithm, an RSA encryption algorithm, a HASH encryption algorithm or an MD5 encryption algorithm, and then the encrypted commodity information is extracted according to a special rule and format such as a front-to-rear split-half method or a fixed format and is fragmented into the two half codes; and then, the two half codes are encrypted using the data transformation algorithm); and the other half code is stored to the commodity information database of the remote server 4.

When an inspection system for commodity uniqueness confirmation in the disclosure inspects, first of all, an image of an outer code label printed on a surface of a commodity packaging box and overlaid with anti-counterfeiting information A is shot by a mobile terminal 3. Then, the image of the outer code label is uploaded to a remote server 4 after being corrected by the mobile terminal 3; and thereafter, after the commodity packaging box is unwrapped, inner code information B on an inner code label is input and is uploaded to the remote server 4. At last, the remote server 4 performs analysis on the uploaded image of the outer code label to obtain overlaid anti-counterfeiting information A, pairs with information in a commodity information database via the anti-counterfeiting information A and the inner code information B, inspects and feeds corresponding information of a purchased commodity back to the mobile terminal 3; and meanwhile, the remote server 4 updates a statistical record of a sold database, determines a uniqueness of the purchased commodity and feeds an inspected unique structure back to the mobile terminal 3. In addition, the mobile terminal 3 further identifies a correspondence address of a remote server 4 of a merchant corresponding to the image of the outer code label while correcting the image of the outer code label, and uploads the corrected image of the outer code label and the inner code information B to the remote server 4 at the correspondence address.

In this way, through the inspection system of the disclosure, the commodity uniqueness can be confirmed, the operation is simple and convenient, and while the misinput is prevented, the malicious query as well as the disturbance to correct statistics and tracking of the merchant is avoided; moreover, the inner code information B of the inner code label is not known before the commodity is purchased, so after the commodity is purchased, it is difficult to reversely deduce out the anti-counterfeiting information A by referring to outer image information (outer code label); the uploaded image of the counterfeited outer code label cannot be analyzed by the remote server of the merchant, such that the correct commodity information and the uniqueness confirmation cannot be fed back; and thus, the large-scale counterfeiting cannot be implemented, and the anti-counterfeiting purpose is achieved.

The above are preferable embodiments of the disclosure. It should be noted that those of ordinary skill in the art may make various improvements and alternations to the disclosure without departing from the principle of the disclosure and all of these alternations and improvements are covered by the scope of protection of the disclosure.

What is claimed is:

1. An inspection system for commodity uniqueness confirmation, comprising: an outer code label, an inner code label, a mobile terminal and a remote server, wherein
the outer code label is a pattern printed on a surface of a commodity packaging box and overlaid with anti-counterfeiting information A; the inner code label is arranged inside the commodity packaging box, on which inner code information B covered by a coating can be scraped;
the mobile terminal is a terminal device having image collection and mobile communication functions, and is mainly configured to collect a pattern overlaid with the anti-counterfeiting information A, and the inner code information B, and upload the pattern overlaid with the anti-counterfeiting information A, and the inner code information B together to the remote server via a wireless communication network;
the remote server is mainly configured to perform analysis on the uploaded pattern overlaid with the anti-counterfeiting information A, compare the pattern and the inner code information B together with information in a commodity information database, determine a uniqueness of a purchased commodity and feed the uniqueness back to the mobile terminal;
the mobile terminal is connected with the remote server via the mobile communication network.

2. The inspection system for the commodity uniqueness confirmation according to claim 1, wherein the anti-counterfeiting information A is overlaid and printed on the surface of the commodity packaging box with the following method: first of all, image information and the anti-counterfeiting information A are obtained, and the anti-counterfeiting information A is encoded and is added to concentration information I of the image information; and then, the concentration information I added with the anti-counterfeiting information A is restored into a color image and the color image is directly printed on the surface of the commodity packaging box via a printer.

3. The inspection system for the commodity uniqueness confirmation according to claim 2, wherein the anti-counterfeiting information A is to perform encryption and fragmentation on the commodity information to form one of two half codes that are uniquely corresponding; and the other half code is stored to a commodity information database of the remote server.

4. The inspection system for the commodity uniqueness confirmation according to claim 3, wherein said “to perform the encryption and the fragmentation on the commodity information to form the two half codes that are uniquely corresponding” is specifically as follows: the commodity information is encrypted first using a data transformation algorithm, and then the encrypted commodity information is extracted according to a special rule and format and is fragmented into the two half codes; or the commodity information is extracted according to the special rule or format and is fragmented into the two half codes, and then, the two half codes are encrypted using the data transformation algorithm.

5. The inspection system for the commodity uniqueness confirmation according to claim 4, wherein the data transformation algorithm refers to a symmetric or asymmetric key algorithm, or a Triple Data Encryption Algorithm (3DES), Rivest-Shamir-Adleman (RSA), HASH or Message-Digest Algorithm 5 (MD5) encryption algorithm; the special rule and format refer to a front-to-rear split-half method or a fixed format.

6. The inspection system for the commodity uniqueness confirmation according to claim 1, wherein the pattern overlaid with the anti-counterfeiting information A is a two-dimensional code, a barcode or a graph.

7. An inspection method for commodity uniqueness confirmation, comprising:
first of all, shooting, by a mobile terminal, an image of an outer code label printed on a surface of a commodity packaging box and overlaid with anti-counterfeiting information A;
then, after correcting the image of the outer code label, uploading, by the mobile terminal, to a remote server, and then after unwrapping the commodity packaging box, inputting inner code information B on an inner code label and uploading to the remote server; and
at last, performing analysis, by the remote server, on the uploaded image of the outer code label to obtain overlaid anti-counterfeiting information A, pairing with information in a commodity information database via the anti-counterfeiting information A and the inner code information B, inspecting and feeding corresponding information of a purchased commodity back to the mobile terminal; and meanwhile, updating a statistical record of a sold database, determining a uniqueness of the purchased commodity and feeding an inspected unique structure back to the mobile terminal.

8. The inspection method according to claim 7, wherein the mobile terminal further identifies a correspondence address of a remote server of a merchant corresponding to the image of the outer code label while correcting the image of the outer code label, and uploads the corrected image of the outer code label and the inner code information B to the remote server at the correspondence address.
